(19) United States
(12) Patent Application Publication
(10) Pub. No.: US 2016/0258196 A1
(43) Pub. Date: Sep. 8, 2016

(54) HINGE DEVICE

(71) Applicant: SHIROKI CORPORATION, Fujisawa-shi, Kanagawa (JP)

(72) Inventors: Kenji YAMAMOTO, Fujisawa-shi, Kanagawa (JP); Kazuki NATSUME, Fujisawa-shi, Kanagawa (JP)

(21) Appl. No.: 15/028,387

(22) PCT Filed: Oct. 21, 2014
(86) PCT No.: PCT/JP2014/077951

§ 371 Date: Apr. 8, 2016

(30) Foreign Application Priority Data
Nov. 1, 2013 (JP) 2013-228189

(51) Int. Cl. E05D 3/14

(52) U.S. Cl. CPC E05D 3/145; E05Y 2900/548

(57) ABSTRACT

Provided is a hinge device in which in a closed state of a lid, a first link (25) includes a first main body portion (25a) that is attached to a body bracket (21) and extends along the body bracket (21) and a first bent portion (25b) that is bent from the first main body portion (25a) toward a lid bracket (23) and is attached to the lid bracket (23), a second link (31) includes a second main body portion (31a) that is attached to the lid bracket (23) and extends along the lid bracket (23) and a second bent portion (31b) that is bent from the second main body portion (31a) toward the body bracket (21) and is attached to the body bracket (21), and a gap (S) is formed between the body bracket (21) and the lid bracket (23).

### TECHNICAL FIELD

The present invention relates to a hinge device that rotatably supports a lid that is able to open and close an opening of a vehicle.

### BACKGROUND ART

A background hinge device will be described with reference to FIG. 6. FIG. 6 is a diagram illustrating a closed state of the background hinge device. The hinge device rotatably supports a lid that is able to open and close an opening of a vehicle.

In FIG. 6, a body bracket 1 is provided to the vehicle so as to extend along a vehicle front-rear direction.

A lid bracket 3 is provided to the lid so as to face the body bracket 1 in a fully-closed state where the lid covers the opening.

One end of a first link 5 is rotatably attached to the body bracket 1, and the other end thereof is rotatably attached to the lid bracket 3 at a side of a rotating base portion of the lid.

One end of a second link 7 is rotatably attached to the body bracket 1 and the other end thereof is rotatably attached to the lid bracket 3 at a side of a rotating end potion of the lid.

The body bracket 1, the lid bracket 3, the first link 5, and the second link 7 form a four-node rotation mechanism, in which the body bracket 1 is fixed (For example Patent Literature 1).

### CITATION LIST

### Patent Literature

Patent Literature 1: Japanese Patent Application Laid-Open No. 2000-96914

### SUMMARY OF INVENTION

### Problems to be Solved

In the hinge device illustrated in FIG. 6, a space S surrounded by the body bracket 1, the lid bracket 3, the first link 5, and the second link 7 is formed. The distance between the body bracket 1 and the lid bracket 3 in the space S decreases as the lid approaches a closed state.

In such a hinge device, if a piece of luggage (hereinafter referred to as a foreign object) or the like in the trunk enters into the space S and is sandwiched between the body bracket 1 and the lid bracket 3 when a user closes the lid, malfunction of the hinge device may occur.

The present invention has been made in view of the above problem and an object thereof is to provide a hinge device in which malfunction unlikely occurs.

### Solution to Problem

In order to achieve at least one of the objects, according to an aspect of the present invention, A hinge device that rotatably supports a lid being able to open and close an opening of a vehicle, the hinge device includes: a lid bracket, which is provided to the lid along a direction of radius of rotation of the lid; a body bracket, which is provided to the vehicle and faces the lid bracket in a fully-closed state where the lid covers the opening; a first link, one end of which is rotatably attached to the body bracket and the other end of which is rotatably attached to a rotating center portion of the lid, at a side of the lid bracket; and a second link, one of which end is rotatably attached to the body bracket and the other end of which is rotatably attached to a rotating end portion of the lid, at a side of the lid bracket than the first link, wherein, in the fully-closed state of the lid, the first link includes: a first main body portion that is attached to the body bracket and extends along the body bracket; and a first bent portion that is bent from the first main body portion toward the lid bracket and is attached to the lid bracket, the second link includes: a second main body portion that is attached to the lid bracket and extends along the lid bracket; and a second bent portion that is bent from the second main body portion toward the body bracket and is attached to the body bracket, and a gap is provided between the body bracket and the lid bracket.

The other features of the present invention will become more apparent from the embodiment of the present invention and the accompanying drawings.

### Advantageous Effects of Invention

According to the present invention, since the first and second bent portions have a large length, it is easy to form a large gap between the body bracket and the lid bracket even when the lid is in a closed state.

Therefore, malfunction of the hinge device due to a foreign object sandwiched between the body bracket and the lid bracket unlikely occurs.

The other effects of the present invention will become more apparent from the embodiment of the present invention and the accompanying drawings.

### BRIEF DESCRIPTION OF DRAWINGS

FIG. 1 is a side view of a hinge device according to a first embodiment in a fully-closed state of a lid.

FIG. 2 is a side view of the hinge device illustrated in FIG. 1 in a fully-opened state of the lid.

FIG. 3 is a perspective view along the direction indicated by arrow III in FIG. 1.

FIG. 4 is a perspective view along the direction indicated by arrow IV in FIG. 2.

FIG. 5 is a perspective view of a trunk in which the hinge device illustrated in FIG. 1 is formed.

FIG. 6 is a diagram illustrating a closed state of a background hinge device that rotatably supports a lid that is able to open and close an opening of a trunk.

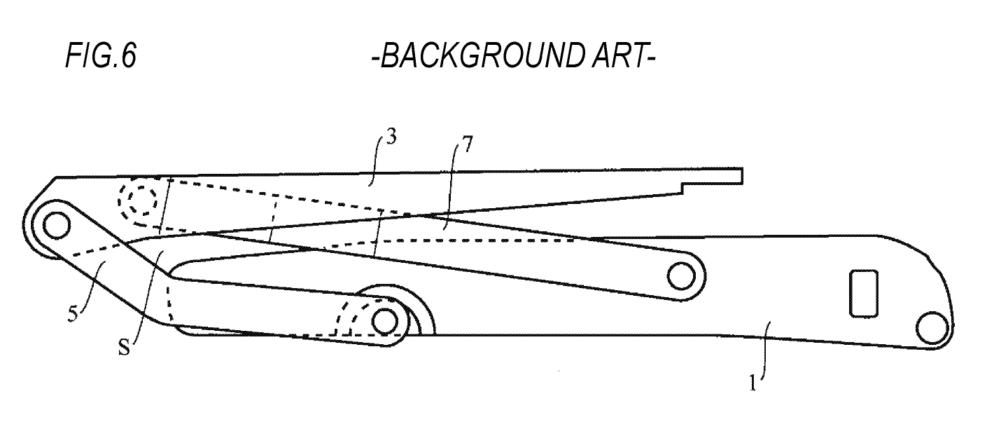

### DESCRIPTIONS OF EMBODIMENTS

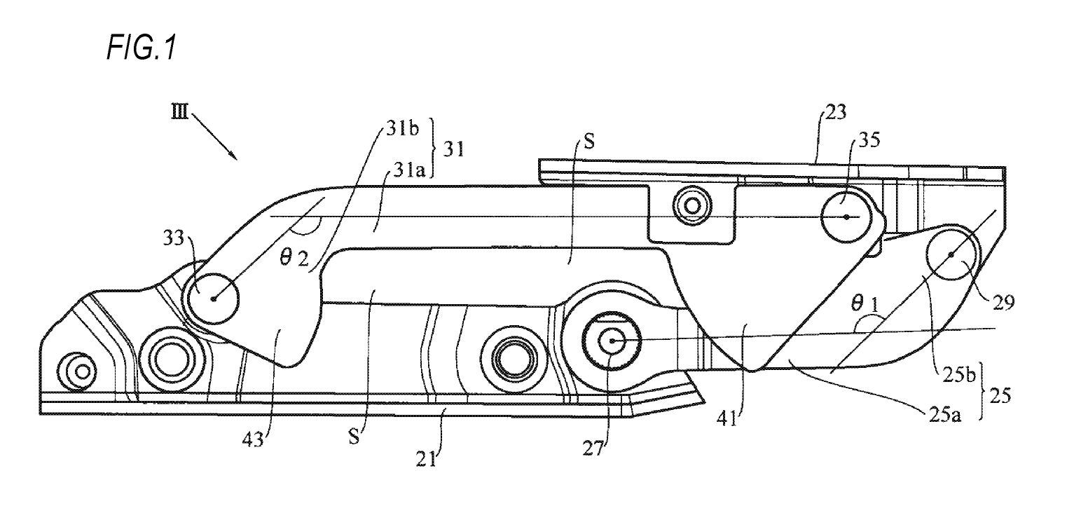

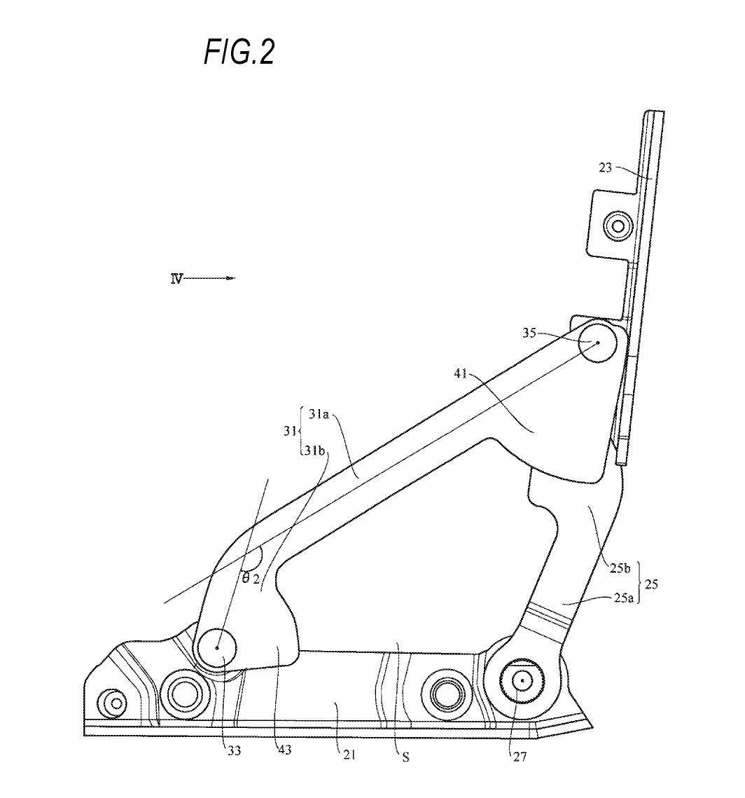

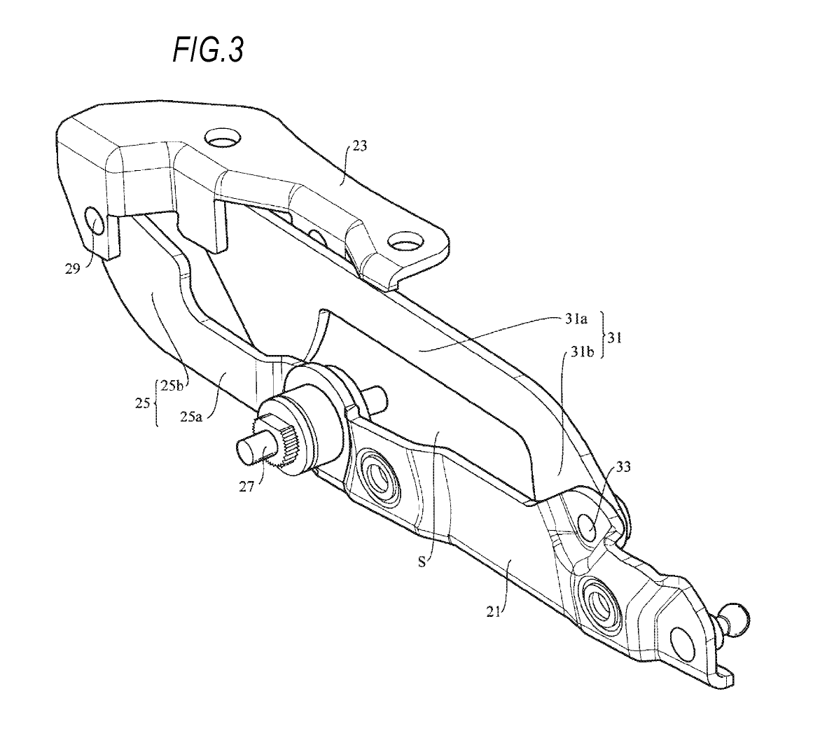

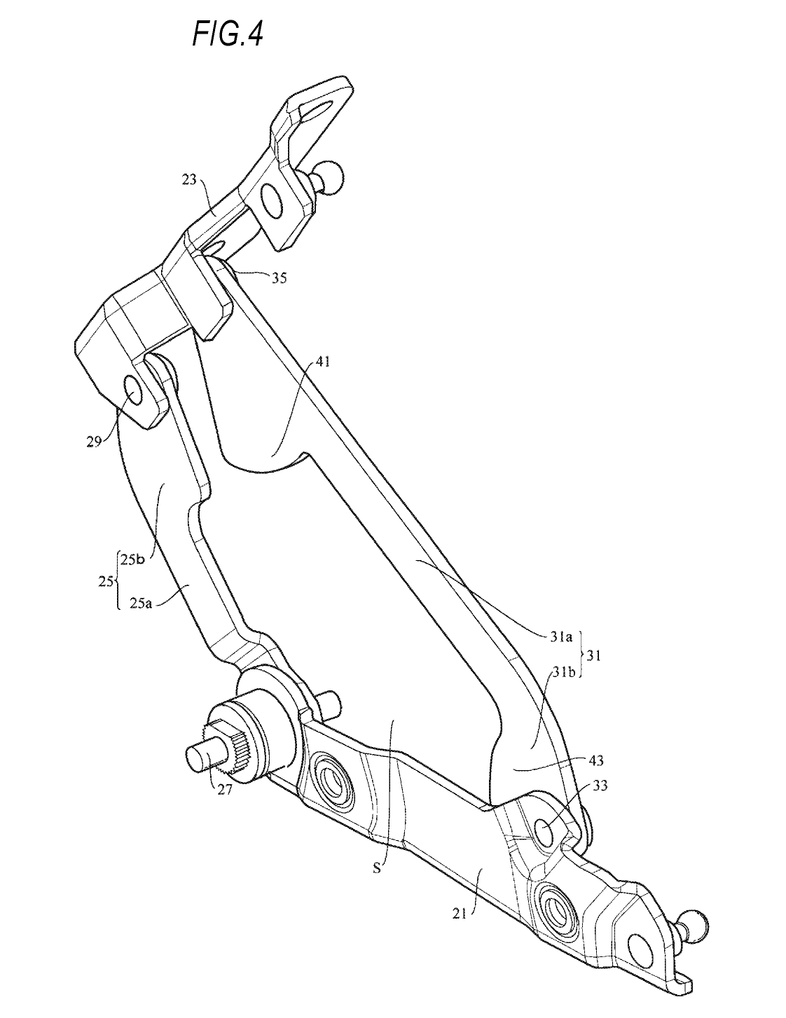

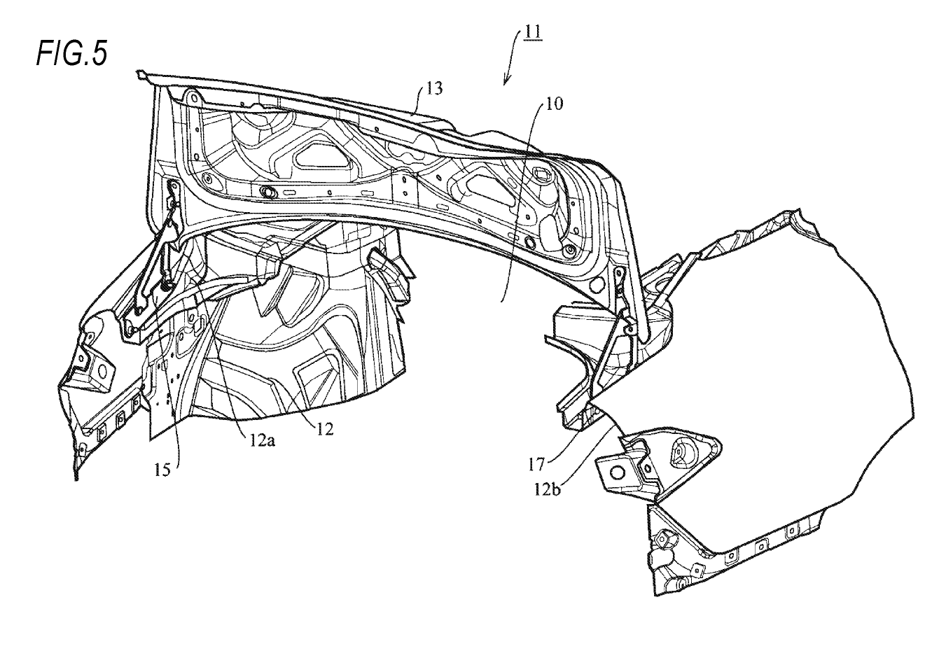

A hinge device according to a first embodiment of the present invention will be described with reference to FIGS. 1 to 5. FIG. 1 is a side view of a hinge device according to a first embodiment in a fully-closed state of a lid; FIG. 2 is a side view of the hinge device illustrated in FIG. 1 in a fully-opened state of the lid; FIG. 3 is a perspective view along the direction indicated by arrow III in FIG. 1; FIG. 4 is a perspective view along the direction indicated by arrow IV in FIG. 2; and FIG. 5 is a perspective view of a trunk in which the hinge device illustrated in FIG. 1 is formed.

First, an entire configuration of a trunk will be described with reference to FIG. 5. As illustrated in FIG. 5, a trunk 11 formed at the rear part of a vehicle has a luggage space 12 to store the luggage. An opening 10 for taking luggage in and out from the outside of the vehicle is provided to the luggage space 12. Moreover, a lid (cover) 13 for opening and closing the opening 10 is provided to the vehicle.

Hinge devices 15 and 17 are provided to upright walls 12a and 12b that extend in a vehicle front-rear direction of the luggage space 12. The hinge devices 15 and 17 rotatably support the lid 13 that can open and close the opening 10.

The hinge devices 15 and 17 of the present embodiment have the same structure. Thus, the hinge device 15 will be described with reference to FIGS. 1 to 5, and the description of the hinge device 17 will be omitted.

A lid bracket 23 extended in the direction of radius of rotation of the lid 13 is formed on the backside of the lid 13.

A body bracket 21 is provided to the upright wall 12a (the vehicle) of the luggage space 12. The body bracket 21 faces the lid bracket 23 in a fully-closed state where the lid 13 covers the opening 10. More specifically, the body bracket 21 extends in a depth direction of the luggage space 12 of the trunk 11. In the present embodiment, the “depth direction” of the luggage space 12″ is the same as a “vehicle length direction of the luggage space 12” or a “vehicle front-rear direction.” Further, in the present embodiment, the lid bracket 23 and the body bracket 21 are formed to be parallel when the lid 13 is fully-closed.

One end of the first link 25 is attached to a drive shaft 27. The drive shaft 27 is rotatably formed on the body bracket 21, at a far side in the depth direction of the luggage space 12 of the trunk 11. The other end of the first link 25 is rotatably attached to the lid bracket 23, at a side of the rotating center portion of the lid 13 with a pin 29 interposed therebetween.

The drive shaft 27 is rotated by a drive source (not illustrated).

One end of the second link 31 is rotatably attached to the body bracket 21, at a near side in the depth direction of the luggage space of the trunk 11 with a pin 33 interposed therebetween.

The other end of the second link 31 is rotatably attached to the lid bracket 23, at a side of a rotating end portion of the lid 13 by a pin 35.

In the present embodiment, the side of the rotating center portion of the lid 13 is the front side in the vehicle front-rear direction, and the side of the rotating end portion of the lid 13 is the rear side in the vehicle front-rear direction.

A rotation axis of the first link 25 with respect to the lid bracket 23, a rotation axis of the first link 25 with respect to the body bracket 21, a rotation axis of the second link 31 with respect to the lid bracket 23, and a rotation axis of the second link 31 with respect to the body bracket 21 are parallel to each other and extend in a direction vertical to the sheet surface of FIG. 1.

As viewed from the direction of the rotation axis, the first link 25 and the second link 31 are formed so that a virtual segment connecting the rotation axis of the first link 25 with respect to the lid bracket 23 and the rotation axis of the first link 25 with respect to the body bracket 21 does not cross a virtual segment connecting the rotation axis of the second link 31 with respect to the lid bracket 23 and the rotation axis of the second link 31 with respect to the body bracket 21. In the following description, unless otherwise stated, the hinge device will be described as viewed from the direction parallel to the rotation axis.

The body bracket 21, the lid bracket 23, the first link 25, and the second link 31 form a four-node rotation mechanism in which the body bracket 21 is fixed.

As illustrated in FIGS. 1 and 3, in the closed state of the lid 13, the first link 25 includes a first main body portion 25a, which is attached to the body bracket 21 and extends along the body bracket 21, and a first bent portion 25b, which is bent from the first main body portion 25a toward the lid bracket 23 and is attached to the lid bracket 23.

In the closed state of the lid 13, the second link 31 includes a second main body portion 31a, which is attached to the lid bracket 23 and extends along the lid bracket 23, and a second bent portion 31b, which is bent from the second main body portion 31a toward the body bracket 21 and is attached to the body bracket 21.

As illustrated in FIGS. 1 and 2, as viewed from the direction of the rotation axis, a gap S is always formed between the body bracket 21 and the lid bracket 23 while the lid 13 is changing from the fully-closed state to the fully-opened state.

In the present embodiment, as illustrated in FIG. 1, a first bending angle θ1, which is the angle of bending of the first bent portion 25b with respect to the first main body portion 25a, and a second bending angle θ2, which is the angle of bending of the second bent portion 31b with respect to the second main body portion 31a, are set to a right angle or an obtuse angle.

Unlike the illustrated example, as viewed from the direction of the rotation axis, if at least one of the bending angles θ1 and θ2 is an angle other than the right angle, a narrow portion in a height direction (the up-down direction of the drawing sheet of FIG. 1) is provided to a portion of the gap S near the attachment portion of the second main body portion 31a attached to the lid bracket 23 and the attachment portion of the second bent portion 31b attached to the body bracket 21.

Alternatively, as compared to the gap between the lid bracket 23 and the body bracket 21, as viewed from the direction of the rotation axis, the gap between the first bent portion 25b and the second main body portion 31a (or the lid bracket 23) and the gap between the second bent portion 31b and the body bracket 21 are more likely to narrow when the lid 13 is fully closed, as illustrated in FIG. 1 That is, as viewed from the direction of the rotation axis, the regions of the gap S near both ends in the left-right direction are likely to narrow when the lid 13 is fully closed, as illustrated in FIG. 1.

Accordingly, a cover portion 41 that covers the narrow portion of the gap S is formed at the attachment portion of the second main body portion 31a of the second link 31 attached to the lid bracket 23. This cover portion 41 has a portion that overlaps the first link 25 while the lid 13 is changing from the fully-closed state to the fully-opened state.

Meanwhile, a cover portion 34 that covers the narrow portion of the gap S is formed at the attachment portion, which is attached to the body bracket 21, of the second bent portion 31b of the second link 31. This cover portion 43 has a portion that overlaps the body bracket 21 while the lid 13 is changing from the fully-closed state to the fully-opened state.

The cover portion 41 according to the present embodiment is formed to be integrated with the second link 31 in a fan shape that spreads about the pin 35.

Due to these cover portions 41, while the lid 13 is changing from the fully-closed state to the fully-opened state, it is possible to cover the gap between the first bent portion 25b and the second main body portion 31a (or the lid bracket 23) or the gap between the second bent portion 31b and the body bracket 21 while always securing the gap between the lid bracket 23 and the body bracket 21. Therefore, a foreign object will not enter into the narrow gap, and even when a foreign object is present, the foreign object can be located in the gap between the lid bracket 23 and the body bracket 21. Thus, malfunction of the hinge device will unlikely occur.

Further, as illustrated in FIG. 4, the attachment portion, which is attached to the body bracket 21, of the first main body portion 25a of the first link 25 the attachment portion, which is attached to the lid bracket 23, of the first bent portion 25b, the attachment portion, which is attached to the lid bracket 23, of the second main body portion 31a of the second link 31, and the attachment portion, which is attached to the body bracket 21, of the second bent portion 31b are offset in a vehicle width direction (the direction of the rotation axis). In other words, the plane by rotating of the first link 25 and the plane by rotating of the second link 31 are formed at different positions in the vehicle width direction. Therefore, a gap is provided between the first link 25 and the second link 31 in the vehicle width direction.

According to such a configuration, the following advantages are obtained.

(1) When the lengths of the first bent portion 25b of the first link 25 and the second bent portion 31b of the second link 31 are set to be long, even when the lid 13 is in the closed state as illustrated in FIGS. 1 and 3, a large gap can be provided between the body bracket 21 and the lid bracket 23.

Thus, malfunction of the hinge device due to a foreign object sandwiched between the body bracket 21 and the lid bracket 23 will unlikely occur.

(2) When the cover portion 41 having the portion that overlaps the first link 25 while the lid 13 is changing from the fully-closed state to the fully-opened state as viewed from the direction of the rotation axis is formed, the narrow portion of the gap S is covered. When the cover portion 43 having the portion that overlaps the body bracket 21 while the lid 13 is changing from the fully-closed state to the fully-opened state is formed, the narrow portion of the gap S is covered.

(3) The first bending angle θ1, which is the angle of bending of the first bent portion 25b with respect to the first main body portion 25a, and the second bending angle θ2, which is the angle of bending of the second bent portion 31b with respect to the second main body portion 31a, are set to a right angle or an obtuse angle. Therefore, as compared to a case where the first and second bending angles θ1 and θ2 are acute angles, the lengths of the first main body portion 25a of the first link 25 and the main body portion 31a of the second link 31 can be shorten.

(4) Since the plane by rotating of the first link 25 and the plane by rotating of the second link 31 are formed at different positions in the vehicle width direction, a gap can be provided between the first and second links 25 and 31 in the vehicle width direction. Therefore, malfunction of the hinge device due to a foreign object sandwiched between the first and second links 25 and 31 will unlikely occur.

Additionally, The present invention is not limited to the embodiment.

In the embodiment, although the cover portion that covers a portion of the gap S is formed to be integrated with the link, the cover portion may be separated from the link. The shape of the cover portion is not limited to the fan shape but may be a triangular shape or the like.

Further, the cover portion may be provided to at least one attachment portion of: the attachment portion, which is attached to the body bracket 21, of the first main body portion 25a; the attachment portion, which is attached to the lid bracket 23, of the first bent portion 25b; the attachment portion, which is attached to the lid bracket 23, of the second main body portion 31a; and the attachment portion, which is attached to the body bracket 21, of the second bent portion 31b.

Moreover, although the first bending angle θ1 which is the angle of bending of the first bent portion 25b with respect to the first main body portion 25a and the second bending angle θ2 which is the angle of bending of the second bent portion 31b with respect to the second main body portion 31a are set to a right angle or an obtuse angle, any one of the first and second bending angles θ1 and θ2 may be a right angle or an obtuse angle.

The present application is based on Japanese Patent Application (No. 2013-228189) filed on Nov. 1, 2013, and the contents of which are hereby incorporated by reference.

### INDUSTRIAL APPLICABILITY

According to the present invention, a hinge device in which malfunction of the hinge device due to a foreign object sandwiched between the body bracket and the lid bracket unlikely occurs is provided.

### REFERENCE SIGNS LIST

21: Body bracket
23: Lid bracket
25: First link
25a: First main body portion
25b: First bent portion
31: Second link
31a: Second main body portion
31b: Second bent portion

1. A hinge device that rotatably supports a lid being able to open and close an opening of a vehicle, the hinge device comprising:
a lid bracket, which is provided to the lid along a direction of radius of rotation of the lid;
a body bracket, which is provided to the vehicle and faces the lid bracket in a fully-closed state where the lid covers the opening;
a first link, one end of which is rotatably attached to the body bracket and the other end of which is rotatably attached to a rotating center portion of the lid, at a side of the lid bracket; and
a second link, one of which end is rotatably attached to the body bracket and the other end of which is rotatably attached to a rotating end portion of the lid, at a side of the lid bracket than the first link,
wherein, in the fully-closed state of the lid,
the first link includes: a first main body portion that is attached to the body bracket and extends along the body bracket; and a first bent portion that is bent from the first main body portion toward the lid bracket and is attached to the lid bracket,
the second link includes: a second main body portion that is attached to the lid bracket and extends along the lid bracket; and a second bent portion that is bent from the second main body portion toward the body bracket and is attached to the body bracket, and
a gap is provided between the body bracket and the lid bracket.

2. The hinge device according to claim 1,
wherein a cover portion that covers the gap is provided to at least one attachment portion of: an attachment portion, which is attached to the body bracket, of the first main body portion; an attachment portion, which is attached to the lid bracket, of the first bent portion; an attachment portion, which is attached to the lid bracket, of the second main body portion; and an attachment portion, which is attached to the body bracket, of the second bent portion.

3. The hinge device according to claim 2,
wherein the cover portion is provided to at least one attachment portion of: the attachment portion, which is attached to the lid bracket, of the second main body portion; and the attachment portion, which is attached to the body bracket, of the second bent portion, and has a portion that overlaps the body bracket while the lid is being from the fully-closed state to the fully-opened state.
